(19) United States
(12) Patent Application Publication
(10) Pub. No.: US 2005/0094673 A1
(43) Pub. Date: May 5, 2005

(54) Signal generator for digital broadcasting

(76) Inventors: Minoru Nishiyama, Kanagawa-ken (JP); Susumu Akada, Kanagawa-ken (JP)

Correspondence Address: FISH & RICHARDSON P.C., 1425 K STREET, N.W., 11TH FLOOR, WASHINGTON, DC, 20005-3500, US

(21) Appl. No.: 10/967,177

(22) Filed: Oct. 19, 2004

(30) Foreign Application Priority Data
Oct. 31, 2003 (JP) 371659/2003

(51) Int. Cl. H04J 1/00

(52) U.S. Cl. 370/486; 725/143

(57) ABSTRACT

A digital broadcasting signal generator improved in usability incorporates a TS generator section which generates a color bar TS signal, a digital modulation section which modulates the color bar TS signal in accordance with one digital broadcasting system selected from a plurality of digital broadcasting systems, and an up-converter section which converts the frequency of the color bar TS signal. The plurality of digital broadcasting systems are an ISDN system, a DVB system and an ATSC system.

### BACKGROUND OF THE INVENTION

The present invention relates to a signal generator for digital broadcasting. More particularly, the present invention relates to a device which therein generates a transport stream (TS) and modulates the TS in accordance with one digital broadcasting system selected from a plurality of digital broadcasting systems, and thereby, generates a signal for digital broadcasting.

FIG. 1 shows an example of a conventional testing system for digital broadcasting. As shown in FIG. 1, the conventional testing system has a TS generator 10 which generates a test TS signal, a digital modulator 11 which modulates the test TS signal in a digital modulation manner, an up-converter 12 which converts the frequency of the test TS signal, and an evaluation apparatus 13.

Test signals which can be used in the testing system include, for example, a simple moving image signal, a still image signal and a color bar signal. Description will be made of use of a color bar signal by way of example. The TS generator 10 encodes a color bar signal (test TS signal) by the MPEG-2-Video method, multiplexes the encoded color bar signal by the MPEG-2-Systems method to generate a color bar TS signal (test TS signal). The TS generator 10 outputs the color bar TS signal to the modulator 11. Color bar signals which can be generated by the TS generator 10 include a field color bar signal, an EIA color bar signal and an SMPT color bar signal.

The digital modulator 11 is supplied with the color bar TS signal from the external TS generator 10. Modulation methods for digital ground broadcasting include those which conform with Integrated Services Digital Broadcasting-Terrestrial transmission (ISDB-T) used in Japan, Digital Video Broadcasting-Terrestrial (DVB-T) used in Europe and Advanced Television Systems Committee (ATSC) employed in the USA, and the modulator is selected dependent on the modulation method. In other words, the conventional digital modulator 11 conforms to only one digital broadcasting system. The ISDB-T digital modulator 11 performs digital modulation of the color bar TS signal in accordance with the ISDB-T system, and outputs the modulated color bar TS signal to the up-converter 12. (Alternatively, the DVB-T digital modulator 11 performs digital modulation of the color bar TS signal in accordance with the DVB-T system, or the ATSC digital modulator 11 performs digital modulation of the color bar TS signal in accordance with the ATSC system.)

The up-converter 12 is supplied with the modulated color bar TS signal from the external digital modulator 11. The up-converter 12 is selected dependent on the modulation method used for modulation in the digital modulator 11. The up-converter 12 converts the frequency of the modulated color bar TS signal into a frequency in accordance with one predetermined digital broadcasting system and outputs the color bar signal TS having the converted frequency to the evaluation apparatus 13.

The evaluation apparatus 13 (e.g., a television set, a tuner or a set-top box) is supplied to the color bar signal from the up-converter 12.

FIG. 2 shows another example of a conventional testing system for digital broadcasting. As shown in FIG. 2, a digital broadcasting signal generator 200 of the conventional testing system is supplied with a color bar TS signal in a state of being connected to an external TS generator 10, stores the color bar TS signal in a storage 20, and is thereafter disconnected from the external TS generator 10. In other words, the digital broadcasting signal generator 200 does not internally generate the color bar TS signal and only reproduces the color bar TS signal generated by the TS generator 10. The conventional digital broadcasting signal generator 200 includes an up-converter section 22 therein.

A digital modulation section 21 of the digital broadcasting signal generator 200 reads out the color bar TS stored in the internal storage 20, performs digital modulation of the color bar TS signal and outputs the modulated color bar TS signal to the up-converter section 22. Note that the conventional digital modulator 21 conforms to only one digital broadcasting system.

The up-converter section 22 is supplied with the modulated color bar TS signal from the digital modulation section 21. The up-converter section 22 converts the frequency of the modulated color bar TS signal into a frequency in accordance with one predetermined digital broadcasting system and outputs the color bar signal TS having the converted frequency to an external evaluation apparatus 13.

Concrete and general examples of the configurations of modulators supplied with a TS signal and modulating the TS signal in accordance with the ISDB-T system are described in Patent Documents 1 and 2 shown below.
[Patent Document 1] Japanese Patent Laid-Open No. 2001-274764 (FIGS. 1 and 8)
[Patent Document 2] Japanese Patent Laid-Open No. 2003-60595 (FIGS. 1 and 4)

### SUMMARY OF THE INVENTION

An object of the present invention is to provide a digital broadcasting signal generator having improved usability.

Other objects of the present invention will become apparent to those skilled in the art from the description of a preferred embodiment of the invention with reference to the accompanying drawings.

A digital broadcasting signal generator of the present invention incorporates a TS generator section which generates a color bar TS signal, and a digital modulation section which modulates the color bar TS signal. Preferably, the digital modulation section modulates the test TS signal in accordance with one digital broadcasting system selected from a plurality of digital broadcasting systems.

The digital broadcasting signal generator of the present invention incorporates the TS generator section, thereby eliminating the need for separately providing a TS generator and a modulator when a testing system for digital broadcasting is constructed. Also, according the present invention, the interface for input from the outside required for each of the conventional TS generator and modulator is not required, and there is no need for development of a control program for the interface. Further, the digital broadcasting signal generator in accordance with the present invention does not require a storage device for temporarily storing a color bar TS signal and reproducing the TS signal. Therefore, the digital broadcasting signal generator can be reduced in size.

The digital broadcasting signal generator of the present invention incorporates the digital modulation section in conformity with a plurality of digital broadcasting systems, thereby eliminating the need for separately preparing a plurality of modulators in conformity with digital broadcasting systems in different countries when a testing system conforming to the plurality of digital broadcasting systems is constructed.

### BRIEF DESCRIPTION OF THE DRAWINGS

FIG. 1 is a diagram showing an example of a conventional testing system for digital broadcasting;

FIG. 2 is a diagram showing another example of a conventional testing system for digital broadcasting;

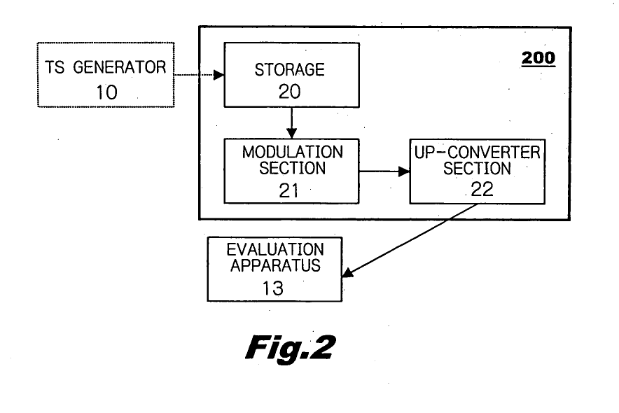

FIG. 3 is a diagram showing an example of the configuration of a testing system having a digital broadcasting signal generator of the present invention; and

FIG. 4 is a diagram showing details of an example of the configuration of a digital modulation section in conformity with the ISDB-T system.

### DETAILED DESCRIPTION OF THE INVENTION

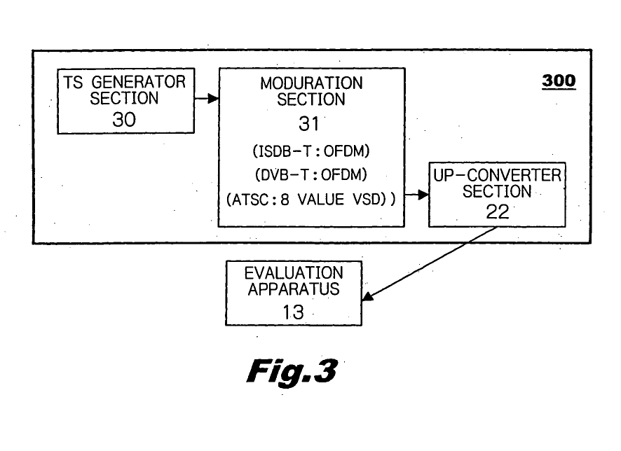

FIG. 3 shows an example of the configuration of a testing system having a digital broadcasting system in accordance with the present invention. As shown in FIG. 3, a digital broadcasting signal generator 300 of the present invention has internal sections: a TS generator section 30 which generates a test TS signal, a digital modulation section 31 which modulates the test TS signal in accordance with one digital broadcasting system selected from a plurality of digital broadcasting systems, and an up-converter section 22 which converts the frequency of the test TS signal.

The plurality of digital broadcasting systems include an ISDB system (including ISDB-S, ISDB-C, ISDB-T and ISDB-T_{SB} systems), a DVB system (including DVB-S, DVB-C, DVB-T systems) and an ATSC system. In the case of digital ground broadcasting, the ISDB-T system is used and DVB-T system is also used. While the digital broadcasting signal generator described below is for digital ground broadcasting, it is to be noted that the present invention is not limited to digital ground broadcasting.

The TS generator section 30 encodes a generated test signal by the MPEG-2-Video method, and multiplexes the encoded test signal by the MPEG-2-Systems method to generate a test TS signal (e.g., a color bar TS signal). The TS generator 30 outputs the test TS signal to the modulator 11.

The digital modulation section 31 is supplied with the test TS signal from the TS generator section 30. The digital modulation section 31 can modulate the test TS signal in accordance with one digital ground broadcasting system selected by a user in correspondence with one of three digital ground broadcasting systems: the ISDB-T system, the DVB-T system and the ATSC system. When the ISDB-T system is selected as a digital ground broadcasting system, the digital modulation section 31 performs orthogonal frequency division multiplexing (OFDM) modulation on the test TS signal. When the DVB-T system is selected as a digital ground broadcasting system, the digital modulation section 31 also performs OFDM modulation on the test TS signal. When the ATSC system is selected as a digital ground broadcasting system, the digital modulation section 31 performs 8-value vestigial side band (VSB) modulation on the test TS signal.

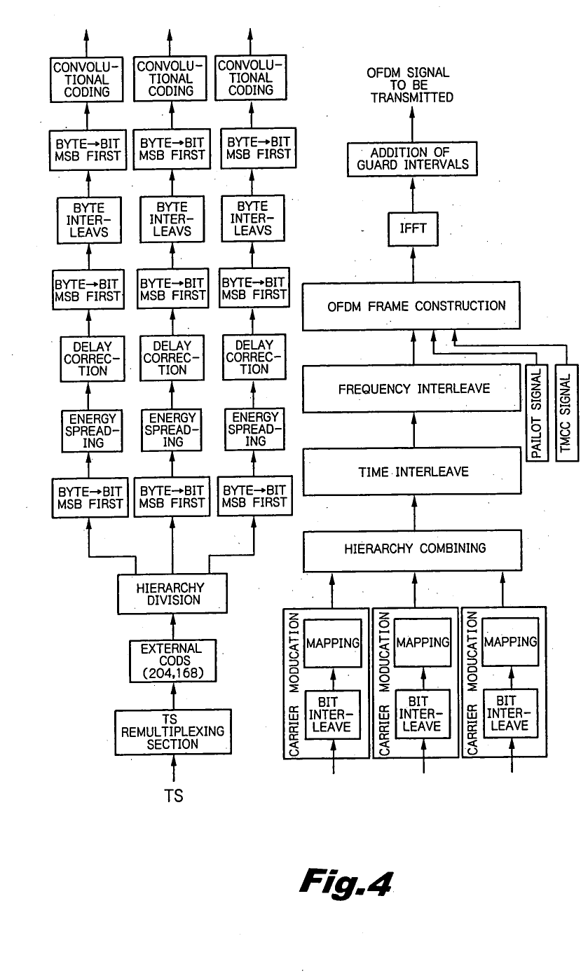

FIG. 4 shows details of an example of the configuration of the digital modulation section in conformity with the ISDB-T system. Digital modulations in accordance with the DVB-T system and the ATSC system are well-known techniques and, therefore, will not be described in detail in this specification.

The up-converter section 22 is supplied with the modulated test signal from the digital modulation section 31. The up-converter section 22 conforms to the digital broadcasting system in each country. More specifically, the up-converter section 22 converts the frequency of the modulated color bar TS signal into a frequency in accordance with one broadcasting system selected by the user and outputs the test TS signal having the converted frequency to an evaluation apparatus 13.

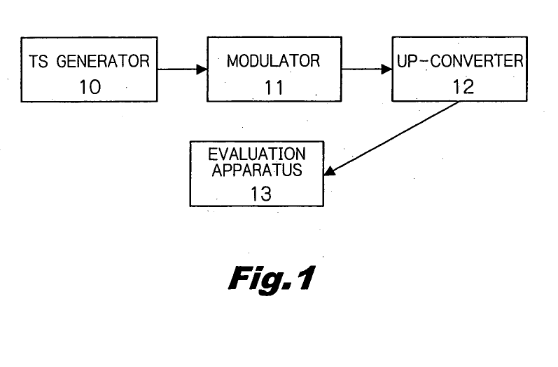

Needless to say, the digital broadcasting signal generator of the present invention is not limited to the above-described embodiment, and various modifications and changes may be made in the described embodiment without departing from the gist of the present invention. For example, an external up-converter such as that shown in FIG. 1 may be adopted instead of the up-converter section 22 shown in FIG. 3.

1. A digital broadcasting signal generator comprising therein:
a TS generator section which generates a test TS signal; and
a digital modulation section which modulates the test TS signal.

2. The digital broadcasting signal generator according to claim 1, wherein said digital modulation section modulates the test TS signal in accordance with one digital broadcasting system selected from a plurality of digital broadcasting systems.

3. The digital broadcasting signal generator according to claim 2, wherein the plurality of digital broadcasting systems are an ISDB system, a DVB system and an ATSC system.

4. The digital broadcasting signal generator according to claim 1, wherein the test TS signal comprises a color bar TS signal.

5. The digital broadcasting signal generator according to claim 1, further comprising therein an up-converter section which converts the frequency of the test TS signal.
